(19) United States
(12) Patent Application Publication
(10) Pub. No.: US 2018/0071701 A1
(43) Pub. Date: Mar. 15, 2018

(54) PORTABLE SUPERCRITICAL FLUID EXTRACTION APPARATUS

(71) Applicant: CO2 Innovation Ltd., Coquitlam (CA)

(72) Inventors: Xiaohui ZHANG, Coquitlam (CA); Ernst C. JANZEN, North Vancouver (CA); Jiabin LIU, St. John's (CA)

(73) Assignee: CO2 Innovation Ltd.

(21) Appl. No.: 15/697,601

(22) Filed: Sep. 7, 2017

Related U.S. Application Data
(60) Provisional application No. 62/394,853, filed on Sep. 15, 2016.

(51) Int. Cl. B01J 3/04; B01D 11/02; B01D 11/04; G01N 30/32

(52) U.S. Cl. CPC B01J 3/042; B01D 11/0203; B01D 11/0407; F17C 2221/013; G01N 2030/326; F17C 2250/0626; F17C 2225/0115; G01N 30/32

(57) ABSTRACT

A portable supercritical fluid extraction apparatus, comprising:
(i) a pressure vessel for generating a supercritical fluid therein;
(ii) a liquid solvent supply tank;
(iii) a means for interconnecting said pressure vessel and said liquid solvent supply tank at a predetermined angle for delivery therethrough of a liquid solvent from the liquid storage tank to the pressure vessel; and
(iv) a heating component for heating contents of the pressure vessel to produce a supercritical fluid therein.

The apparatus may additionally comprise a sample in fluid communication with the pressure vessel, and a receiving vessel in fluid communication with the pressure vessel. The pressure vessel may have a heating means for heating fluid contents therein, for example a heating wrap, a heating block, or a heating jacket.

### TECHNICAL FIELD

This disclosure relates to extraction of organic compounds from solid materials using supercritical fluids. More specifically, this disclosure pertains to apparatus for creation and use of supercritical fluids as liquid solvents for extraction of organic compounds from solid materials.

### BACKGROUND

Industrial-scale supercritical fluid extraction (SFE) facilities have been widely used for example, for decaffeination of coffee beans or teas, for removal of undesired substances from cork, for extraction of essential oils from herbaceous plant materials, for concentration of cannabinoids from cannabis, among other commercial uses. Bench-scale supercritical fluid extraction devices are also commercially available. However, laboratory-scale versions of SFE apparatus are too bulky and too heavy to be carried by an individual. The problems associated with the size and scale of even the smallest commercial SFE apparatus are due to the requirement for a pump component or a compressor plus cooling equipment.

There have been attempts to reduce the size of the components required for successful SFE processing. For example, U.S. Pat. No. 5,637,209 and U.S. Pat. No. 5,237,824 disclosed generation of supercritical carbon dioxide fluid in a generator tank by heating the carbon dioxide to certain temperature in the generator tank, then directing the supercritical carbon dioxide fluid into one or multiple extraction vessels for use in extraction processes. These designs replaced the pump or compressor with a supercritical fluid generator and thus reduced the weight and size of the supercritical fluid extractor to a portable level. However, the problems of bulkiness, excessive weight and size still remain with these smaller scale SFE apparatus.

### SUMMARY

The embodiments of the present disclosure generally relate to a portable supercritical carbon dioxide extraction apparatus that may be carried by one individual and that has mechanically passive components.

### BRIEF DESCRIPTION OF THE FIGURES

The present disclosure will be described in conjunction with reference to the following drawings in which:

FIG. 1 is a schematic illustration of a prior art supercritical fluid extraction (SFE) apparatus disclosed in U.S. Pat. No. 5,237,824;

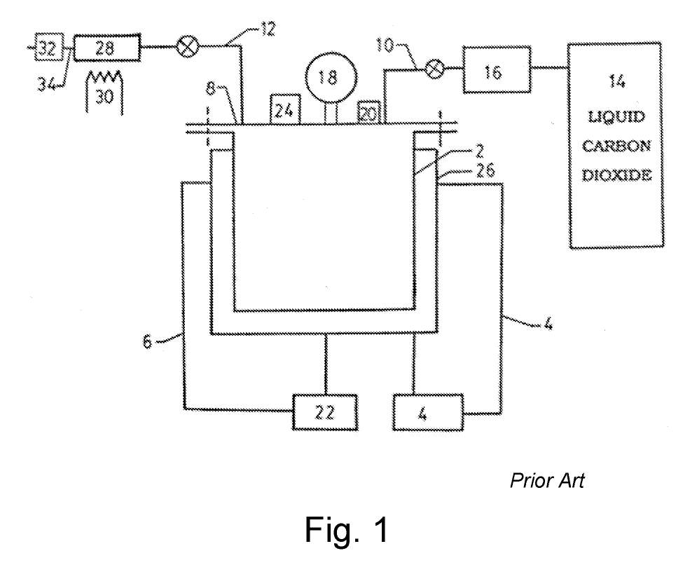

FIG. 2 is a schematic illustration of a prior art supercritical fluid extraction (SFE) apparatus disclosed in U.S. Pat. No. 5,637,209;

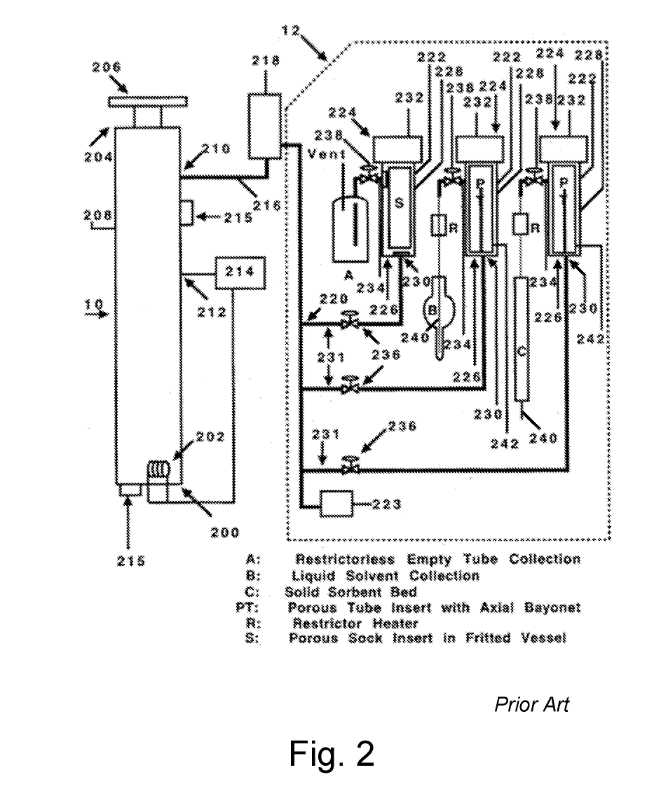

FIG. 3 is a schematic illustration of one embodiment of an apparatus disclosed herein having one extraction vessel, two on/off valves, one heating element, and one reversely placed liquid solvent supplying tank;

FIG. 4 is a schematic illustration of another embodiment of an apparatus disclosed herein having one extraction vessel, two on/off valves, one heating element, and one normally placed liquid solvent supplying tank with dip tube;

FIG. 5 is an isometric illustration of an embodiment of a holder for liquid solvent tanks heavier than 300 g according to one aspect of the present disclosure;

FIG. 6 is an isometric drawing of an extraction vessel connected with a threaded cartridge and a receiving tank according to another aspect of the present disclosure;

FIG. 7 is an isometric drawing of a non-threaded carbon dioxide cartridge with a holder and an adaptor to connect with an on/off valve according to another aspect of the present disclosure;

FIG. 8 is an isometric drawing of a sodastream carbon dioxide tank or a paintball carbon dioxide tank with a holder and an adaptor to connect with an on/off valve according to another aspect of the present disclosure; and

FIG. 9 is an isometric drawing of a carbon dioxide tank with a holder for connection with an on/off valve according to another aspect of the present disclosure.

### DETAILED DESCRIPTION

The embodiments of the present disclosure relate to a portable apparatus for creation and use of supercritical fluids as liquid solvents for extraction of organic compounds from solid materials. The portable supercritical carbon dioxide extraction apparatus may be easily handled and carried by one individual and has mechanically passive components.

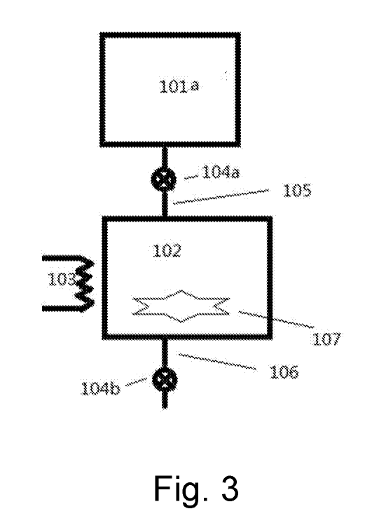

A schematic illustration of a supercritical carbon dioxide extraction apparatus according to one embodiment of the present disclosure is shown in FIG. 3. The apparatus has a reversibly (upside down) standing solvent tank 101a to provide liquid solvent to the system. Keep on/off valves 104a and 104b both closed, but open the extraction vessel 102 and put the solid samples 107 in the extraction vessel 102. Then close 102 and open on/off valve 104a and let liquid solvent pass through inlet 105 and into the extraction vessel 102. Close 104a and start heating 102 with heating element 103 to let liquid solvent in 102 reach supercritical phase and start extracting. When the extraction is done, open on/off valve 104b to release carbon dioxide and extract. Finally, open 102 to take out sample residues and clean 102.

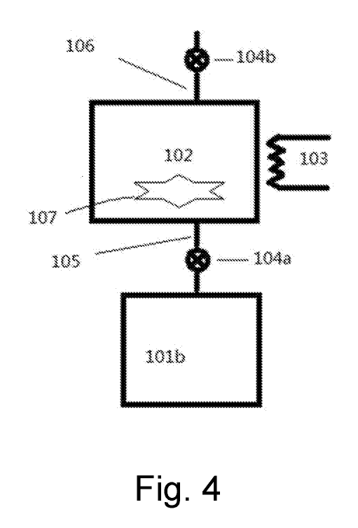

A schematic illustration of another embodiment of a supercritical carbon dioxide extraction apparatus is shown in FIG. 4. The apparatus has a normally (upside up) standing dip-tubed solvent tank 101b to provide liquid solvent to the system. Keep on/off valves 104a and 104b both closed, but open the extraction vessel 102 and put the solid samples 107 in the extraction vessel 102. Then close 102 and open on/off valve 104a and let liquid solvent pass through inlet 105 and into the extraction vessel 102. Close 104a and start heating 102 with heating element 103 to let liquid solvent in 102 reach supercritical phase and start extracting. When the extraction is done, open on/off valve 104b to release carbon dioxide and extract. Finally, open 102 to take out sample residues and clean 102.

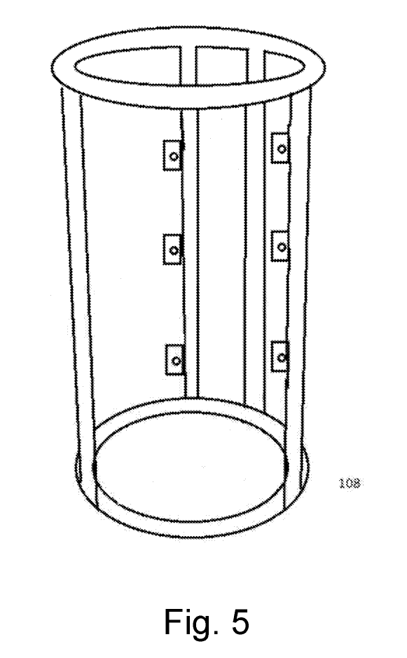

FIG. 5 is an isometric drawing on the holder 108 for fixing heavy carbon dioxide tank. The holder is made by metal. Chains or bands can be tightened through the holes to hold and fix heavy carbon dioxide tank. After the tank is fixed, the holder can be placed either normally or reversely.

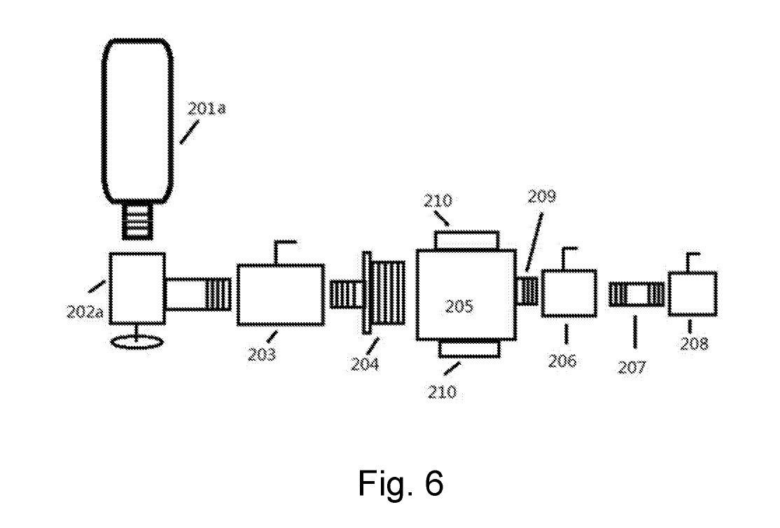

FIG. 6 is an isometric drawing of the extraction vessel connected with a threaded cartridge. Threaded cartridge 201a (such as 12 g, 16 g, 20 g, 25 g, 90 g and other sizes carbon dioxide cartridge or nitrous oxide cartridge) is used to provide liquid carbon dioxide. After filled with sample, with on/off valve 208 turned off, the liquid solvent is filled through an adaptor 202a, an on/off valve 203 and inlet & cap 204 to extraction vessel 205 and further go through the outlet 209 and on/off valve 206 to the receiving tank 207. Turn off 203 to form a closed system. Turning on heating element 210 helps liquid solvents changing to supercritical phase. Repeatedly turning on and off 206 to let supercritical fluid and liquid fluid get balanced. When the extraction is done, keep 203 off, turn off the on/off valve 206, and vent the receiving tank with 208 on. Repeatedly filling 207 from 205, and vent 207, until the extraction fluid is totally emitted. Then collect the extract from 207.

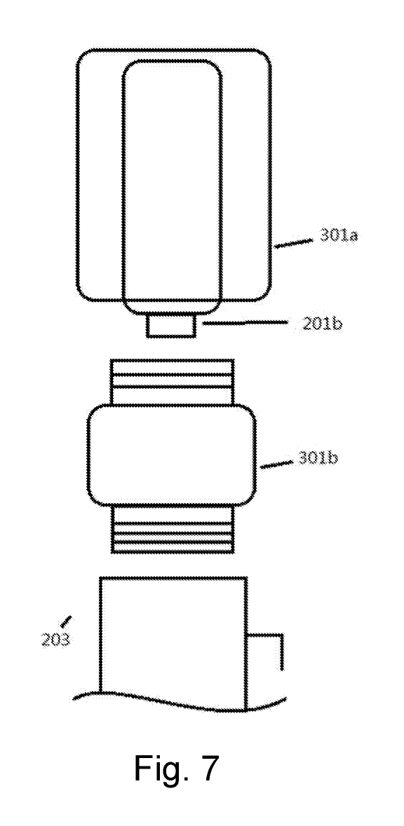

FIG. 7 is an isometric drawing (cross section drawing would be perfect t show the inside of the adaptor 301b) of a non-threaded solvent cartridge 201b with a holder 301a and adaptor 301b. While doing extraction, 301b should be connected with 203.

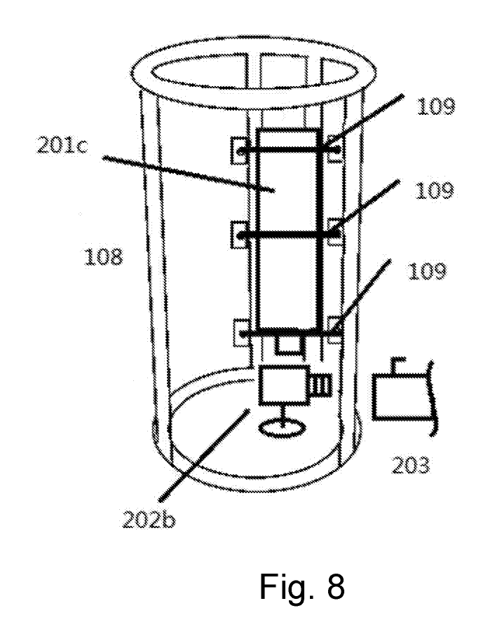

FIG. 8 is an isometric drawing of a Sodastream CARBON DIOXIDE tank 201c or paintball CARBON DIOXIDE 201c tank with a holder 108 and adaptor 202b to connect with the on/off valve 203. The CARBON DIOXIDE tank 201c is reversely fixed by chains or stripes 109 to the holder 108.

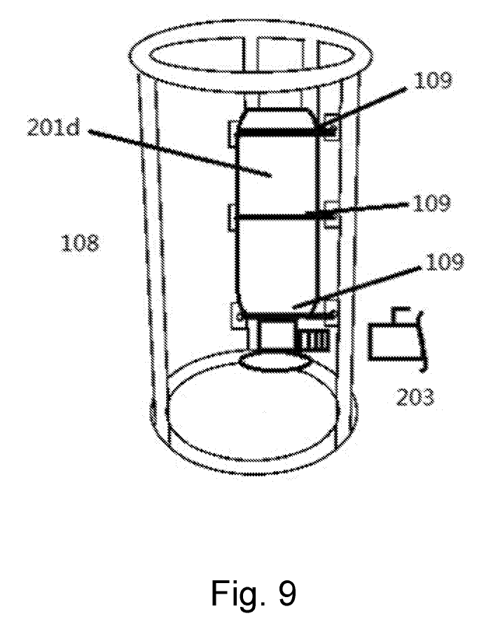

FIG. 9 is an isometric drawing of a regular CARBON DIOXIDE tank 201d from brewery stores, welding stores, or other CARBON DIOXIDE suppliers, such as Airgas and Praxair, with a holder 108 and to connect with the on/off valve 203. The CARBON DIOXIDE tank 201d is reversely fixed by chains or stripes 109 to the holder 108.

Other suitable solvents for use with the portable supercritical fluid extraction apparatus disclosed herein include nitrous oxide, propane, butane, methane, ethane, n-pentane, n-hexane, n-heptane, acetonitrile, acetone, methanol, ethanol, isopropanol, carbon disulfide, ammonia, xenon, water, fluoroform, sulfur hexafluoride, monofluoromethane, dichloromethane, chloroform, chlorotrifluoromethane, chlorodifluoromethane, difluoromethane, benzene, cyclohexane, isobutene, hydrogen sulfide, and 2,2-dimethyl propane.

The liquid solvent supply tank for containing and supplying the solvents to the pressure vessel may be a non-threaded cartridge or a threaded cartridge. The non-threaded cartridge or a threaded cartridge may be a 7.5-gram cartridge, a 10-gram cartridge, a 12-gram cartridge, a 15-gram cartridge, a 20-gram cartridge, a 25-gram cartridge, a 50-gram cartridge, a 75-gram cartridge, a 100-gram cartridge, and therebetween. Alternatively, the liquid solvent supply tank may be a 2.5-lb tank, a 5-lb tank, a 10-lb tank, a 15-lb tank, a 20-lb tank, a 25-lb tank, a 25-lb tank, a 50-lb tank, a 75-lb tank, a 100-lb tank, a 150-lb tank, a 200-lb tank, a 220-lb tank, and therebetween.

According to some aspects, the apparatus disclosed herein comprises means for joining said pressure vessel and said liquid solvent supplying tank or cartridge with various sized adaptors to sealably connect said solvent-supplying tanks or cartridges to said pressure vessel.

According to some aspects, the apparatus disclosed herein have predetermined angles for inverting and sitting the solvent supplying tank or cartridge sealably connecting with the pressure vessel, and wherein the dip-tubed solvent supplying tank or cartridge is situated in an upright position to supply the solvent to the pressure vessel.

According to some aspects, the apparatus disclosed herein has a heating means for the pressure vessel selected from the group of heating wraps, heating blocks, and heating jackets.

According to one embodiment of the present disclosure, the portable supercritical fluid extraction apparatus is provided with a sample infuser in fluid communication with the pressure vessel. The sample infuser is configured for receiving therein a sample and infusing the sample with a supercritical fluid. The sample infuser may have a shape selected from the group of a cylindrical tube, tube having a hairpin shape, a portafilter shape, conical shape, a spherical shape, and a ball shape.

According to another embodiment of the present disclosure, the portable supercritical fluid extraction apparatus is additionally provided with a receiving tank in communication with the pressure vessel for receiving therein an extract produced by infusing the sample with the supercritical fluid. According to one aspect, the receiving tank may comprise a vent for venting the solvent. According to another aspect, the receiving tank may have an access port for removing the extract therethrough.

According to an embodiment of the present disclosure, the receiving tank may function to receive from the pressure vessel and optionally store therein the tank, an extract. Additionally, the receiving tank may receive the supercritical fluid from the pressure vessel, and condense the supercritical fluid into an ambient liquid form.

### EXAMPLES

### Example 1

With 10 ml extraction vessel, when it's filled at 20° C., 17 g liquid carbon dioxide can be filled. And heat the extraction vessel to 50° C., the pressure of the extraction vessel would reach 1600 psi. The pressure and temperature exceeds the critical point of the carbon dioxide. The density of supercritical carbon dioxide in the vessel is 1.7 g/cm³ or 1700 Kg/m³.

### Example 2

When the 10 ml extraction vessel is filled at 8° C., 46 g liquid carbon dioxide can be filled. And heat the extraction vessel to 50° C., the pressure of the extraction vessel would reach 4000 psi. And heat the extraction vessel to 70° C., the pressure of the extraction vessel would reach 5400 psi. The above parameters of pressure and temperature all exceed the critical point of the carbon dioxide. The density of supercritical carbon dioxide in the vessel is 4.6 g/cm³ or 4600 Kg/m³.

Present apparatus simplified the apparatus by omitting the supercritical fluid generator tank, and only using an extraction vessel to complete both supercritical fluid generating and extracting work. Thus several advantages of one or more aspects are that the supercritical fluid extraction apparatus can be lighter and smaller. Other advantages of one or more aspects are that the supercritical fluid extraction apparatus can be used to fit various solvent sources, ranging from gram level carbon dioxide cartridges, hundreds grams level sodastream carbon dioxide tank, paintball carbon dioxide tanks, carbon dioxide tanks from welding shops, brewing stores, and other carbon dioxide suppliers; nitrous oxide cartridges or tanks; propane cartridges or tanks; butane cartridges or tanks; ammonia cartridges or tanks; and so on. Other advantages of one or more aspects are that with the light weight and small size, the present apparatus can be used for on-site extraction work for lab usage or commercial usage, such as decaffeinate coffee in coffee store, extracting tetrahydrocannabinol from cannabis or nicotine from tobacco.

The present apparatus can be coupled with a coffee machine to make decaffeinated coffee. The present apparatus may alternatively coupled with vaporizers or inhalers for cannabis or tobacco usage.

1. A portable supercritical fluid extraction apparatus, comprising:
(i) pressure vessel for generating a supercritical fluid therein;
(ii) a liquid solvent supply tank;
(iii) a means for interconnecting said pressure vessel and said liquid solvent supply tank at a predetermined angle for delivery therethrough said interconnecting means of a liquid solvent from the liquid solvent supply tank to the pressure vessel; and
(iv) a heating component for heating contents of the pressure vessel to produce a supercritical fluid therein.

2. The apparatus of claim 1, additionally comprising a sample infuser in fluid communication with the pressure vessel, said sample infuser configured for receiving a sample therein and infusing the sample with the supercritical fluid to produce an extract therefrom.

3. The apparatus of claim 2, wherein the sample infuser has a shape selected from one of a cylindrical tube, tube having a hairpin shape, a portafilter shape, conical shape, a spherical shape, and a ball shape.

4. The apparatus of claim 1, additionally comprising a receiving tank in fluid communication with the pressure vessel, for receiving the extract therein.

5. The apparatus of claim 4, wherein the receiving tank is provided with a vent for venting solvent.

6. The apparatus of claim 4, wherein the receiving tank is provided with an access port.

7. The apparatus of claim 1, additionally comprising a heating means for the pressure vessel.

8. The apparatus of claim 7, wherein the heating means is one of a heating wrap, heating block, and a heating jacket.

9. The apparatus of claim 1, wherein said pressure vessel is fabricated with a metal material selected from the group consisting of stainless steel, titanium, aluminum, copper, and titanium alloy.

10. The apparatus of claim 1, wherein said liquid solvent can be converted to a supercritical fluid within the pressure vessel by concurrent application of (i) a pressure from the range of 0 to 10,000 pounds per square inch (0 to 680.5 atmosphere), and (ii) a temperature from the range of 200° to 473° Kelvin.

11. The apparatus of claim 1, wherein the liquid solvent is one of carbon dioxide, nitrous oxide, propane, butane, methane, ethane, n-pentane, n-hexane, n-heptane, acetonitrile, acetone, methanol, ethanol, isopropanol, carbon disulfide, ammonia, xenon, water, fluoroform, sulfur hexafluoride, monofluoromethane, dichloromethane, chloroform, chlorotrifluoromethane, chlorodifluoromethane, difluoromethane, benzene, cyclohexane, isobutene, hydrogen sulfide, and 2,2-dimethyl propane.

12. The apparatus of claim 1, wherein the liquid solvent supply tank is one of a carbon dioxide tank, a nitrous oxide tank, a propane tank, a butane tank, a methane tank, an ethane tank, a n-pentane tank, a n-hexane tank, a n-heptane tank, an acetonitrile tank, an acetone tank, a methanol tank, an ethanol tank, an isopropanol tank, a carbon disulfide tank, an ammonia tank, a xenon tank, a water tank, a fluoroform tank, a sulfur hexafluoride tank, a monofluoromethane tank, a dichloromethane tank, a chloroform tank, a chlorotrifluoromethane tank, a chlorodifluoromethane tank, a difluoromethane tank, a benzene tank, a cyclohexane tank, an isobutene tank, a hydrogen sulfide tank, and a 2,2-dimethyl propane tank.

13. The apparatus of claim 1, wherein the liquid solvent supply tank is one of a non-threaded carbon dioxide cartridge, a threaded carbon dioxide cartridge, and a carbon dioxide tank.

14. The apparatus of claim 13, wherein the non-threaded carbon dioxide cartridge is one of a 15-gram cartridge, a 25-gram cartridge, a 50-gram cartridge, a 75-gram cartridge, a 100-gram cartridge, and therebetween.

15. The apparatus of claim 13, wherein the threaded carbon dioxide cartridge is one of a 7.5-gram cartridge, a 10-gram cartridge, a 12-gram cartridge, a 15-gram cartridge, a 20-gram cartridge, a 25-gram cartridge, a 50-gram cartridge, a 75-gram cartridge, a 100-gram cartridge, and therebetween.

16. The apparatus of claim 13, wherein the carbon dioxide tank is one of a 2.5-lb tank, a 5-lb tank, a 10-lb tank, a 15-lb tank, a 20-lb tank, a 25-lb tank, a 25-lb tank, a 50-lb tank, a 75-lb tank, a 100-lb tank, a 150-lb tank, a 200-lb tank, a 220-lb tank, and therebetween.
